(19) United States
(12) Patent Application Publication
(10) Pub. No.: US 2006/0098387 A1
(43) Pub. Date: May 11, 2006

(54) Conductive gasket and material therefor

(76) Inventors: Satish Chandra, Lansdale, PA (US); Mohamed Ait El Cadi, La Varenne (FR); Richard Thibeau, Blairstown, NJ (US); Jean-Alec Ducros, Fontainebleau (FR)

Correspondence Address: PITNEY HARDIN LLP, 7 TIMES SQUARE, NEW YORK, NY, 10036-7311, US

(21) Appl. No.: 10/258,426

(22) PCT Filed: Jan. 26, 2001
(86) PCT No.: PCT/US01/02562

§ 371 Date: Nov. 22, 2005

Related U.S. Application Data
(60) Provisional application No. 60/199,152, filed on Apr. 24, 2000.

(51) Int. Cl. H01G 4/005

(52) U.S. Cl. 361/303

(57) ABSTRACT

A conductive gasket and a paste for the electrical industry based on at least one elastomer (10) and on an admixture of conductive particles in the form of fibers (20), in which the fibers (20) are flexible and have been embedded in the elastomer (10) in random orientation and with formation of a large number of contact points between fibers.

### BACKGROUND OF THE INVENTION

The invention relates to gaskets having electrically conductive properties for use in shielding the emission of electromagnetic waves from electronic devices and to a conductive paste for use in the electrical industry that can be used to form such gaskets.

Conventional electrically conductive shielding gaskets can be formed with glass spheres and pure metallic powders and can be used for shielding at input/output (I/O) panels in electronic devices such as computers, to prevent leakage of electromagnetic waves and radio frequency interference (RFI). Gaskets can be formed with a foam inner body and conductive fabric disposed around the foam inner body. Others are formed of conductive polymers and conductive elastomers or with foam bodies coated with conductive elastomer or polymer materials. For many fine detailed operations, it is advantages to provide the gasket material in paste form.

Materials of this type are widely used and are required by a wide variety of applications. They have gained particular importance, for example, in connection with the sealing of electromagnetically shielded housings in electronic devices which emit electromagnetic radiation or can be disturbed by electromagnetic radiation penetrating from outside. To give EMI (electromagnetic interference) shielding or, respectively, RFI (radio frequency interference) shielding, and to improve electromagnetic compatibility (EMC), the housings are produced from a material which is electrically conducting or has been coated with an electrical conductor. It is known that gaskets made from an electrically conductive flexible material can be used so that the region of the joints at which the parts of the housing are joined together is also given shielding.

An example of a material of this type is known from U.S. Pat. No. 4,011,360, the contents of which are incorporated by reference. This known material is based on an elastomer, specifically a silicone rubber material, which has an admixture of electrically conducting particles therein. This material polymerizes (cures) when exposed to atmospheric moisture at room temperature.

DE 43 19 965 C2, the contents of which are incorporated herein by reference discloses the use of a material of this type for producing the housings described above. The material is extruded as a strand of paste directly in the region of the joint onto one of the parts of the housing, and is cured there to form the gasket. This process is also known by the skilled worker as the formed-in-place-gasket process.

Existing gaskets, such as formed-in-place gaskets lack sufficient flexibility for certain applications. Others, can lack sufficient EMI shielding properties. Still others are difficult to use. Accordingly, it is desirable to provide an improved conductive shielding gasket and a paste for forming a gasket in place, which overcomes drawbacks of the prior art.

### SUMMARY OF THE INVENTION

The invention is based on the concept of using conductive particles in the form of fibers which are flexible. These are admixed in random orientation with the elastomer in a way which produces a large number of contact points. The embedding of the fibers in the elastomer therefore takes the form of an irregular three-dimensional matrix. The contact points ensure ideal and statistically random distribution conductivity within the material.

Depending on the nature of the fibers used, one preferred embodiment allows the selected proportion of fibers to be less than 50%, based on the total volume of the material. It is preferably possible to reduce the proportion of fibers to less than 25% by volume. Compared with materials previously available, this gives a significant improvement in mechanical properties, in particular in the flexibility of the polymerized final product, which is moreover very inexpensive.

It is preferable for the fibers used to have a diameter/length ratio of more than 2. Ideal results can be achieved if the diameter/length ratio is more than 10 and even more than 50. The shape of fibers of this type makes them highly flexible, and they therefore give an ideal result with regard to the mechanical properties of the final product.

An embodiment further optimized in this respect provides for the use of fibers with a diameter of less than 0.1 mm. These extremely thin fibers can be embedded into the elastomer in an ideal manner, such that the embedded fibers have virtually no adverse effect on the flexibility of the elastomer.

It is also possible to design the material in a manner known as a two- or multicomponent material such as reactive materials in which a cure agent is mixed with a polymerizable or otherwise curable resin. The two components are not mixed until immediately prior to processing. This method can give a very inexpensive material which is easy to process.

Depending on the application, the material selected may be one which polymerizes (cures) at room temperature. On the other hand it is also possible to provide a material which polymerizes on exposure to heat, so that the polymerization procedure can be controlled by controlling temperature. This is of particular importance with a view to automated mass production.

The formulation of the material is preferably such that it has low viscosity. It is therefore particularly suitable for forming an electrically shielding gasket for a housing, the material for the gasket being applied in the form of a strand directly in the region of a joint of a housing. Typical applications for a material of this type are the formation of a gasket for a mobile telephone housing or the like. However, the viscosity should not be too low, or it will run and not stay in place until cured. Typical strands of paste and gaskets formed therefrom can be about 1-5 mm wide. In other embodiments of the invention, the strand can be wider or thinner than this range.

It is also possible to design a material with high viscosity, for example in order to produce sealing elements in the form of sealing strips, sealing pads, sealing tubes or O-rings, by injection molding or extrusion.

One specific example of an application provides for the use of the conductive paste for producing a flexible gasket for an electromagnetically shielded housing. A paste of the material is applied by means of a path-controlled nozzle directly to a part of the housing in the region where the housing has a joint to be sealed. The nozzle is moved over the part of the housing by means of computer-controlled metering equipment while the plastics material is being discharged. The velocity of relative movement of the nozzle and the part of the housing is determined by the viscosity of the paste, the amount and velocity of the paste emerging from the nozzle, the cross-sectional area of the nozzle passage, the desired cross-sectional profile of the gasket to be produced and the makeup of the material.

The strand made from the paste and dispensed in this way polymerizes under ambient conditions at room temperature. This procedure takes a relatively long time, but can be accelerated by controlled exposure to heat or through the use of catalysts or accelerators.

The present invention provides a material of the type which can be used as an EMI gasket. The material provided should have improved mechanical properties and moreover be inexpensive, in order for example to open up even those application sectors in which economic reasons have hitherto prevented the use of large elastomer gaskets.

Accordingly, it is an object of the invention to produce a gasket and materials for producing the gasket which are highly conductive, highly flexible and easy to use.

### BRIEF DESCRIPTION OF THE DRAWINGS

The invention is further described below using the example shown diagrammatically in the figures.

FIG. 1 is a cross sectional view of a strand of paste which can be used to form gasket material in accordance with preferred embodiments of the invention;

FIG. 2 shows the gasket strand of FIG. 1 after deformation;

FIG. 3 shows a cross sectional view of a strand of conventional gasket material; and

FIG. 4 shows the gasket strand of FIG. 3 after deformation.

### DETAILED DESCRIPTION OF THE PREFERRED EMBODIMENTS

An elastomeric material containing conductive particles or fibers and method of formation is provided for use as low impedance gasket materials including electromagnetic interference (EMI) gaskets formed from the materials. The particles can be formed from Teflon®, nylon, acrylics, polyesters and other polymer fibers which can be plated, coated or otherwise covered or embedded with conductive material or otherwise rendered conductive, so as to yield highly flexible electrically conductive additives which can be used in the formation of electrically conductive gasket material.

In a preferred embodiment of the invention, the particles are in the nature of fibers of the above materials, coated or plated with electrically conductive materials. One way of rendering the particles electrically conductive is through an electroplating process to provide the particles with a metal surface covering and thereby provide a highly electrically conductive surface on the flexible particles. Suitable metals include silver, copper, nickel or alloys of silver, copper and/or nickel, as well as other combinations and materials which provide low impedance surfaces for the particles. By way of nonlimiting example, preferred particles are in the range of about 10 to 100 microns in average diameter with a length of 20 microns to 1000 microns. In certain embodiments of the invention, the lengths and diameters of the particles could be higher or lower than this range. In other embodiments of the invention the length of the fibers can advantageously range from about 30 microns to even several centimeters in length. Preferred particles should also have a low specific gravity to ensure that they do not settle out of a paste before curing, preferably ranging from about 1.15 to 1.5.

The conductive particles can be combined with compatible elastomeric compounds and formed into appropriate shielding material. Suitable elastomers include compatible silicones, foamed and unfoamed fluoropolymers, EPDM (ethylene-propylene-diene monomer) neoprene, SANTOPRENE™ and other elastomeric materials which are suitably combined with conductive particles/fibers as described herein for use as shielding gaskets as described herein. The conductive particle portion of the elastomeric material is advantageously from about 5% to 50% by weight of the elastomer/compound combination.

One advantageous feature of the conductive shield (gasket) is to provide suitable distribution of the conductive particle fibers, so that sufficient conductive material is present at the surface of the gasket, to provide low impedance and high shielding. It is also important for the particles to be in contact with each other to transmit current from one surface to the other. Thus a large percentage of the particles must be in contact with other particles to present a continuous network of conductive particles from surface to surface.

The paste (uncured material) can be used in compression molding, injection molding and extrusion processes to form preformed gaskets, sleeves, strips, o-rings, tubes and other images.

Electrically conductive particles have exhibited various shapes. Particles frequently encountered in conventional gaskets have the shape of flakes, spheres, irregularly shaped bodies or fibers. In the simplest case, the particles are manufactured directly from conductive material. It is moreover possible to prepare particles from nonconductive materials and then to cover or coat these with conductive material. It has been determined that these particles reduce the elasticity of the cured final product. The elasticity here is given solely by the elastomer into which the particles have been embedded. Forming the particles as flexible fiber strands can therefore yield highly flexible conductive gaskets.

To achieve good conductivity it has generally been necessary to provide more than 50% by volume of conductive particles to ensure the required contact of the particles with one another. The resultant proportion of elastomer has been comparatively small. It has been determined that this also leads to a rigid final product with disadvantageous mechanical properties and high cost.

FIG. 3, for comparison, shows a section of a strand 1′, which is composed of an elastomer 10′ and of an admixture of conductive particles 20′. The conductive particles 20′ have been packed tightly within the elastomer 10′ in order to ensure the required good electrical conductivity via a large number of contact points. The proportion of the particles 20′ by volume, based on the total volume, is about 80%.

In FIG. 4, for comparison, the strand 1′ has been exposed to a force F, as arises in practice for example at a joint of a housing. The deformation shown diagrammatically is possible only if each of the particles 20′ can be displaced to the side. Otherwise deformation is possible only to a very small extent, specifically until the particles 20′ have their maximum close-packed density. It has been determined that this can be improved by using less particles, but making the particles in the form of longer, flexible, conductive strands.

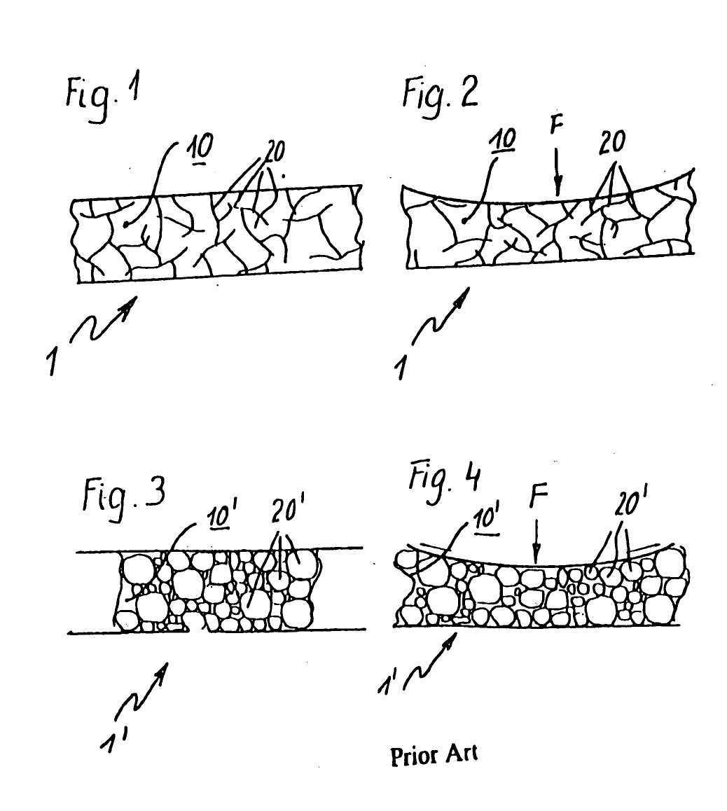

FIGS. 1 and 2 show a strand 1 according to preferred embodiments of the invention. A large number of long, thin, flexible fibers 20 have been embedded in the elastomer material 10. They have random orientation, and the fibers 20 contact one another at a large number of contact points to form a conductive network. Even without deformation, this ensures electrical conductivity, as indicated in FIG. 1.

It can be seen directly from FIG. 2 that relatively problem-free deformation can occur on exposure to a force F. In this case the flexibility of the strand 1 is almost exclusively a function of the flexibility of the elastomer, since the proportion by volume of the fibers 20 is less than 50%. The fibers 20 provide only slight hindrance to the deformation of the strand 1.

There is substantial freedom in the choice of fibers 20. It is preferable to use extremely thin fibers which are relatively long and have a cross section of less than 0.1 mm. The length is at least twice the diameter, but the full effect of the advantage achievable is not seen until very much longer fibers are used, such as these in which the length is 10, 50 and even more than 50 times the diameter. The diameter data above should not be understood as a restriction implying that the only fibers which can be used are those with approximately circular cross-section. Rather, the cross-sectional shapes which may be used include others, and may per se be as desired. Diameter should be understood to refer to the average cross sectional side to side distance regardless whether the particle has a round cross section.

The fibers 20 may be composed of the materials commonly used for particles of this type, including, for example, naturally occurring materials. If the starting material for the fibers is nonconducting, the fibers are covered or coated with conductive material.

The strand 1 shown in FIGS. 1 and 2 has thus been permeated by a type of three-dimensional matrix of fibers 20, and the distribution of the fibers 20 and their contact points with one another, determined statistically over the cross section, is at least approximately constant.

It is apparent from the above that it is possible to form a conductive paste and an EMI shielding gasket from such paste, which has ideal mechanical and electrical properties and is also inexpensive. It is relatively easy here to achieve the desired processing properties, in particular via suitable choice of the elastomer, which may also be in the form of a two- or multicomponent material.

What is claimed is:

1. A conductive paste, comprising: at least one elastomeric material and a plurality of conductive particles in the form of elongated fibers, wherein the fibers are flexible and are substantially uniformly distributed in the elastomeric material in random orientation and with formation of a large number of contact points between contacting fibers.

2. The paste as claimed in claim 1, wherein the proportion of fibers, based on the total volume of the paste, is less than 50% by volume.

3. The paste as claimed in claim 1 wherein the proportion of fibers is less than 25% by volume of the total volume of the paste.

4. The paste as claimed in claim 1, wherein the fibers have a length:diameter ratio of more than 2.

5. The paste as claimed in claim 1, wherein the fibers have a length:diameter ratio of more than 10.

6. The paste as claimed in claim 1, wherein the fibers have a length:diameter ratio of more than 50.

7. The paste as claimed in claim 5, wherein the fibers have a diameter less than about 0.1 mm.

8. The paste as claimed in claim 1, wherein the paste is composed of two or more components which cure immediately after they are combined.

9. The paste as claimed in claim 1, wherein the paste comprises monomers which polymerize at room temperature.

10. The paste as claimed in any of claim 1, wherein the paste comprises monomers which polymerizes on exposure to heat.

11. The paste as claimed in claim 1, wherein the paste has a sufficiently low viscosity to be applied in the form of a strand about 1-5 mm wide, directly in the region of a joint, to form an electrically shielding gasket for a housing.

12. The paste as claimed in claim 1, wherein the paste has a sufficiently high viscosity to be moldable by injection molding or extrusion to provide a sealing element.

13. The paste of claim 1, wherein the fibers comprise metal covered polymer fibers.

14. The paste of claim 1, wherein the elastomer comprises a silicone based elastomer.

15. A conductive EMI shielding gasket having a top and a bottom surface, comprising an elastomeric binder having elongated and flexible electrically conductive fibers substantially evenly distributed therein and substantially each fiber is in contact with another fiber to provide a conductive network of fibers from the top surface to the bottom surface of the gasket.

16. The gasket of claim 15, wherein the binder comprises a silicone based elastomer.

17. The gasket of claim 15, constructed for use in a cellular phone.

18. The gasket of claim 15, wherein the fibers are metal covered polymer fibers.

19. The gasket of claim 15, wherein the fibers have a length to diameter ratio of over about 10.

20. A method of forming a gasket, comprising depositing a gasket shaped strand of a curable paste of elastomeric material having flexible conductive fibers evenly distributed therein and permitting the paste to cure.
